(19) United States
(12) Patent Application Publication
(10) Pub. No.: US 2015/0347174 A1
(43) Pub. Date: Dec. 3, 2015

(54) Method, Apparatus, and System for Migrating Virtual Machine

(71) Applicant: Huawei Technologies Co., Ltd., Shenzhen (CN)

(72) Inventors: Ying Song, Beijing (CN); Yuzhong Sun, Beijing (CN); Xia Zhao, Beijing (CN); Kai Kang, Beijing (CN)

(21) Appl. No.: 14/725,057

(22) Filed: May 29, 2015

(30) Foreign Application Priority Data
May 30, 2014 (CN) 201410240277.1

(51) Int. Cl. G06F 9/455

(52) U.S. Cl. CPC G06F 9/45558; G06F 2009/4557

(57) ABSTRACT

A method, an apparatus, and a system for migrating a virtual machine. In this solution, a to-be-migrated virtual machine is determined from a server with a largest temperature value at a current time, and the to-be-migrated virtual machine is migrated to a destination server. Because a temperature value of the destination server available after the to-be-migrated virtual machine is migrated to the destination server is less than the largest temperature value of the server with the largest temperature value at the current time available before the virtual machine is migrated out from the server with the largest temperature value at the current time, a largest temperature value of a server in a data center is reduced; in addition, during refrigeration, less energy is consumed if the largest temperature value is smaller. Therefore, this solution reduces energy consumed in a refrigeration process.

### CROSS-REFERENCE TO RELATED APPLICATION

This application claims priority to Chinese Patent Application No. 201410240277.1, filed on May 30, 2014, which is hereby incorporated by reference in its entirety.

### TECHNICAL FIELD

The present invention relates to the field of data center technologies, and in particular, to a method, an apparatus, and a system for migrating a virtual machine.

### BACKGROUND

With rapid development of network technologies, a scale of a data center tends to increase rapidly. Improper design of and an improper operation on the data center may lead to over-temperature of the data center, and the over-temperature of the data center may lead to an increase in a fault probability of a server in the data center. Therefore, reducing temperature of the data center is one of the key problems to be resolved for the data center.

Currently, a refrigeration manner is generally used to reduce the temperature of the data center. However, energy consumed in this refrigeration process is mainly related to a largest temperature value of the server, but temperature distribution of servers in the current data center is unbalanced, which leads to relatively large energy consumption in the refrigeration process. Therefore, the current refrigeration manner has a defect of relatively large energy consumption.

### SUMMARY

Embodiments of the present invention provide a method, an apparatus, and a system for migrating a virtual machine, to resolve a problem of large energy consumption in a refrigeration process in the prior art.

Specific technical solutions provided in the embodiments of the present invention are as follows:

According to a first aspect, a method for migrating a virtual machine is provided, including: acquiring a temperature value of each server in a data center at a current time; determining a largest temperature value and a smallest temperature value from the acquired temperature values of the servers in the data center, and calculating a difference between the largest temperature value and the smallest temperature value; when it is determined that the difference reaches a preset threshold, determining a to-be-migrated virtual machine from a server with the largest temperature value at the current time, where the preset threshold is greater than or equal to 0; selecting a destination server from other servers that are included in the data center except the server with the largest temperature value at the current time, where the selected destination server meets the following condition: after the determined to-be-migrated virtual machine is migrated to the destination server, a temperature value of the destination server is less than the largest temperature value; and migrating the determined to-be-migrated virtual machine to the destination server.

With reference to the first aspect, in a first possible implementation manner, the determining a to-be-migrated virtual machine from a server with the largest temperature value at the current time specifically includes: calculating a value of temperature effect exerted on the server with the largest temperature value at the current time by each virtual machine in the server with the largest temperature value at the current time, where the value of temperature effect exerted on the server with the largest temperature value at the current time by each virtual machine is a temperature value variation of the server with the largest temperature value at the current time when each virtual machine runs in the server with the largest temperature value at the current time; determining a largest value of temperature effect from the calculated values of temperature effect exerted on the server with the largest temperature value at the current time separately by all virtual machines; and using a virtual machine with the determined largest value of temperature effect as the determined to-be-migrated virtual machine.

With reference to the first possible implementation manner of the first aspect, in a second possible implementation manner, the calculating a value of temperature effect exerted on the server with the largest temperature value at the current time by each virtual machine in the server with the largest temperature value at the current time includes: acquiring first air outlet temperature obtained by collecting, at a previous sampling time point adjacent to the current time, temperature at an air outlet of the server with the largest temperature value at the current time, and first air inlet temperature obtained by collecting, at the previous sampling time point adjacent to the current time, temperature at an air inlet of the server with the largest temperature value; acquiring a first use rate of a specified hardware device of the server with the largest temperature value at the current time, where the first use rate is specific to each virtual machine in the server with the largest temperature value at the current time, the first use rate is collected at the previous sampling time point adjacent to the current time, and the specified hardware device has an attribute that heat is generated and the generated heat changes with load of the specified hardware device; acquiring a second use rate of the specified hardware device of the server with the largest temperature value at the current time, where the second use rate is collected at each sampling time point in first specified duration previous to the current time; based on the first air outlet temperature, the first air inlet temperature, the first use rate, and the second use rate that are acquired, and a weighted value of the first air outlet temperature, a weighted value of the first air inlet temperature, a weighted value of the first use rate, a weighted value of the second use rate, and an ambient temperature value that are determined, predicting, using a weighted summing manner, a temperature value of the server with the largest temperature value at the current time available after each virtual machine in the server with the largest temperature value at the current time is migrated out from the server with the largest temperature value at the current time; and performing the following step, which is performed on a first virtual machine, on each virtual machine in the server with the largest temperature value at the current time, where the first virtual machine is any virtual machine in all virtual machines in the server with the largest temperature value at the current time: using an absolute value of a temperature difference between a predicted temperature value and the acquired first air outlet temperature as a value of temperature effect exerted on the server with the largest temperature value at the current time by the first virtual machine, where the predicted temperature value is a temperature value of the server with the largest temperature value at the current time after the first virtual machine is migrated out from the server with the largest temperature value at the current time.

With reference to the second possible implementation manner of the first aspect, in a third possible implementation manner, the predicting a temperature value of the server with the largest temperature value at the current time available after each virtual machine in the server with the largest temperature value at the current time is migrated out from the server with the largest temperature value at the current time includes: performing the following steps, which are performed on the first virtual machine, on each virtual machine in the server with the largest temperature value at the current time: obtaining a first product by multiplying the acquired first air outlet temperature by the determined weighted value of the first air outlet temperature; obtaining a second product by multiplying the acquired first air inlet temperature by the determined weighted value of the first air inlet temperature; obtaining a third product by multiplying the acquired first use rate by the determined weighted value of the first use rate; obtaining a fourth product by multiplying the acquired second use rate by the determined weighted value of the second use rate; and adding the first product, the second product, the third product, the fourth product, and the determined ambient temperature value, and using the sum obtained by the adding as the temperature value of the server with the largest temperature value at the current time after the first virtual machine is migrated out from the server with the largest temperature value at the current time.

With reference to the second or the third possible implementation manner of the first aspect, in a fourth possible implementation manner, the determining a weighted value of the first air vent temperature, a weighted value of the first air inlet temperature, a weighted value of the first use rate, a weighted value of the second use rate, and an ambient temperature includes: acquiring second air outlet temperature obtained by collecting, at each sampling time point in a period of time previous to the current time, the temperature at the air outlet of the server with the largest temperature value at the current time; acquiring third air outlet temperature obtained by collecting, at a specified time point corresponding to each sampling time point, the temperature at the air outlet of the server with the largest temperature value at the current time; acquiring second air inlet temperature obtained by collecting, at the specified time point corresponding to each sampling time point, the temperature at the air inlet of the server with the largest temperature value at the current time; acquiring a third use rate of the specified hardware device of the server with the largest temperature value at the current time, where the third use rate is specific to each virtual machine in the server with the largest temperature value at the current time, and the third use rate is collected at the specified time point corresponding to each sampling time point; acquiring a fourth use rate of the specified hardware device of the server with the largest temperature value at the current time, where the fourth use rate is collected in second specified duration corresponding to each sampling time point; and using the acquired second air outlet temperature as a dependent variable, separately using the acquired third air outlet temperature, second air inlet temperature, third use rate, and fourth use rate as an independent variable, and determining, using the weighted summing manner, the weighted value of the first air outlet temperature, the weighted value of the first air inlet temperature, the weighted value of the first use rate, the weighted value of the second use rate, and the ambient temperature value, where: the specified time point corresponding to any sampling time point is previous to the any sampling time point, and duration between the specified time point corresponding to the any sampling time point and the any sampling time point is equal to duration between the current time and a set prediction time point; and the second specified duration corresponding to the any sampling time point is a period of time that is previous to the specified time point corresponding to the any sampling time point and any duration away from the corresponding specified time point.

With reference to the second or the fourth possible implementation manner of the first aspect, in a fifth possible implementation manner, the selecting a destination server from other servers that are included in the data center except the server with the largest temperature value at the current time includes: from the other servers that are included in the data center except the server with the largest temperature value at the current time, selecting by means of screening a server that does not include a virtual machine mutually exclusive with the determined to-be-migrated virtual machine, and/or selecting by means of screening a server that has an idle resource and meets a resource requirement of the determined to-be-migrated virtual machine; predicting a temperature value of each selected server available after the determined to-be-migrated virtual machine is migrated to each selected server; and using a server that is in the selected server and whose corresponding predicted temperature value is less than the largest temperature value as the selected destination server.

With reference to the fifth possible implementation manner of the first aspect, in a sixth possible implementation manner, the using a server that is in the selected server and whose corresponding predicted temperature value is less than the largest temperature value as the selected destination server includes: using any server that is in the selected server and whose temperature value is less than the largest temperature value as the selected destination server.

With reference to the fifth possible implementation manner of the first aspect, in a seventh possible implementation manner, the using a server that is in the selected server and whose corresponding predicted temperature value is less than the largest temperature value as the selected destination server includes: performing the following steps, which are performed on a first server, on each server in the selected servers, where the first server is any server in the selected servers: predicting temperature values of the first server and the server with the largest temperature value at the current time after the determined to-be-migrated virtual machine is migrated to the first server; calculating a difference between a largest temperature value and a smallest temperature value in: the predicted temperature values corresponding to the first server and the server with the largest temperature value at the current time, and measured temperature values obtained by separately measuring other servers in the data center except the first server and the server with the largest temperature value at the current time; and from a calculated difference corresponding to each server in the selected servers, determining a server corresponding to a smallest difference as the selected destination server.

With reference to the seventh possible implementation manner of the first aspect, in an eighth possible implementation manner, the predicting a temperature value of the first server available after the determined to-be-migrated virtual machine is migrated to the first server includes: acquiring fourth air outlet temperature obtained by collecting temperature at an air outlet of the first server at the previous sampling time point adjacent to the current time; acquiring third air inlet temperature obtained by collecting temperature at an air inlet of the first server at the previous sampling time point adjacent to the current time; acquiring a first use rate of the specified hardware device of the server with the largest temperature value at the current time, where the first use rate is specific to the determined to-be-migrated virtual machine, and the first use rate is collected at the previous sampling time point adjacent to the current time; acquiring first total storage space of the server with the largest temperature value at the current time, and acquiring second total storage space of the first server; acquiring a fifth use rate of a specified hardware device of the first server, where the fifth use rate is collected at each sampling time point that is previous to the current time and in the first specified duration; obtaining a fifth product by multiplying the acquired fourth air outlet temperature by the determined weighted value of the first air outlet temperature; obtaining a sixth product by multiplying the acquired third air inlet temperature by the determined weighted value of the first air inlet temperature; obtaining a seventh product by multiplying a product of the acquired first use rate and the determined weighted value of the first use rate by a ratio of the acquired second total storage space to the first total storage space; obtaining an eighth product by multiplying the acquired fifth use rate by the determined weighted value of the second use rate; and adding the fifth product, the sixth product, the seventh product, the eighth product, and the determined ambient temperature value, and using the sum obtained by the adding as the predicted temperature value of the first server available after the determined to-be-migrated virtual machine is migrated to the first server.

With reference to the seventh possible implementation manner of the first aspect, in a ninth possible implementation manner, the predicting a temperature value of the server with the largest temperature value at the current time after the determined to-be-migrated virtual machine is migrated from the server with the largest temperature value at the current time to the first server includes: acquiring the first air outlet temperature obtained by collecting, at the previous sampling time point adjacent to the current time, the temperature at the air outlet of the server with the largest temperature value at the current time; acquiring the first air inlet temperature obtained by collecting, at the previous sampling time point adjacent to the current time, the temperature at the air inlet of the server with the largest temperature value at the current time; acquiring the first use rate of the specified hardware device of the server with the largest temperature value at the current time, where the first use rate is specific to the determined to-be-migrated virtual machine, and the first use rate is collected at the previous sampling time point adjacent to the current time; acquiring the second use rate of the specified hardware device of the server with the largest temperature value at the current time, where the second use rate is collected at each sampling time point that is previous to the current time and in the first specified duration; obtaining the first product by multiplying the acquired first air outlet temperature by the determined weighted value of the first air outlet temperature; obtaining the second product by multiplying the acquired first air inlet temperature by the determined weighted value of the first air inlet temperature; obtaining the third product by multiplying the acquired first use rate by the determined weighted value of the first use rate; obtaining the fourth product by multiplying the acquired second use rate by the determined weighted value of the second use rate; and adding the first product, the second product, the third product, the fourth product, and the determined ambient temperature value, and using the sum obtained by the adding as the predicted temperature value of the server with the largest temperature value at the current time after the determined to-be-migrated virtual machine is migrated from the server with the largest temperature value at the current time to the first server.

According to a second aspect, an apparatus for migrating a virtual machine is provided, including: an acquiring unit configured to acquire a temperature value of each server in a data center at a current time; a calculating unit configured to: determine a largest temperature value and a smallest temperature value from the acquired temperature values of the servers in the data center, and calculate a difference between the largest temperature value and the smallest temperature value; a determining unit configured to determine a to-be-migrated virtual machine from a server with the largest temperature value at the current time when it is determined that the difference reaches a preset threshold, where the preset threshold is greater than or equal to 0; a selecting unit configured to select a destination server from other servers that are included in the data center except the server with the largest temperature value at the current time, where the selected destination server meets the following condition: after the determined to-be-migrated virtual machine is migrated to the destination server, a temperature value of the destination server is less than the largest temperature value; and a migrating unit configured to migrate the determined to-be-migrated virtual machine to the destination server.

With reference to the second aspect, in a first possible implementation manner, when determining the to-be-migrated virtual machine from the server with the largest temperature value at the current time, the determining unit is specifically configured to: calculate a value of temperature effect exerted on the server with the largest temperature value at the current time by each virtual machine in the server with the largest temperature value at the current time, where the value of temperature effect exerted on the server with the largest temperature value at the current time by each virtual machine is a temperature value variation of the server with the largest temperature value at the current time when each virtual machine runs in the server with the largest temperature value at the current time; determine a largest value of temperature effect from the calculated values of temperature effect exerted on the server with the largest temperature value at the current time separately by all virtual machines; and use a virtual machine with the determined largest value of temperature effect as the determined to-be-migrated virtual machine.

With reference to the first possible implementation manner of the second aspect, in a second possible implementation manner, when calculating the value of temperature effect exerted on the server with the largest temperature value at the current time by each virtual machine in the server with the largest temperature value at the current time, the determining unit is specifically configured to: acquire first air outlet temperature obtained by collecting, at a previous sampling time point adjacent to the current time, temperature at an air outlet of the server with the largest temperature value at the current time, and first air inlet temperature obtained by collecting, at the previous sampling time point adjacent to the current time, temperature at an air inlet of the server with the largest temperature value; acquire a first use rate of a specified hardware device of the server with the largest temperature value at the current time, where the first use rate is specific to each virtual machine in the server with the largest temperature value at the current time, the first use rate is collected at the previous sampling time point adjacent to the current time, and the specified hardware device has an attribute that heat is generated and the generated heat changes with load of the specified hardware device; acquire a second use rate of the specified hardware device of the server with the largest temperature value at the current time, where the second use rate is collected at each sampling time point in first specified duration previous to the current time; based on the first air outlet temperature, the first air inlet temperature, the first use rate, and the second use rate that are acquired, and a weighted value of the first air outlet temperature, a weighted value of the first air inlet temperature, a weighted value of the first use rate, a weighted value of the second use rate, and an ambient temperature value that are determined, predict, using a weighted summing manner, a temperature value of the server with the largest temperature value at the current time available after each virtual machine in the server with the largest temperature value at the current time is migrated out from the server with the largest temperature value at the current time; and perform the following step, which is performed on a first virtual machine, on each virtual machine in the server with the largest temperature value at the current time, where the first virtual machine is any virtual machine in all virtual machines in the server with the largest temperature value at the current time: using an absolute value of a temperature difference between a predicted temperature value and the acquired first air outlet temperature as a value of temperature effect exerted on the server with the largest temperature value at the current time by the first virtual machine, where the predicted temperature value is a temperature value of the server with the largest temperature value at the current time after the first virtual machine is migrated out from the server with the largest temperature value at the current time.

With reference to the second possible implementation manner of the second aspect, in a third possible implementation manner, when predicting, using the weighted summing manner, the temperature value of the server with the largest temperature value at the current time available after each virtual machine in the server with the largest temperature value at the current time is migrated out from the server with the largest temperature value at the current time, the determining unit is specifically configured to: perform the following steps, which are performed on the first virtual machine, on each virtual machine in the server with the largest temperature value at the current time: obtaining a first product by multiplying the acquired first air outlet temperature by the determined weighted value of the first air outlet temperature; obtaining a second product by multiplying the acquired first air inlet temperature by the determined weighted value of the first air inlet temperature; obtaining a third product by multiplying the acquired first use rate by the determined weighted value of the first use rate; obtaining a fourth product by multiplying the acquired second use rate by the determined weighted value of the second use rate; and adding the first product, the second product, the third product, the fourth product, and the determined ambient temperature value, and using the sum obtained by the adding as the temperature value of the server with the largest temperature value at the current time after the first virtual machine is migrated out from the server with the largest temperature value at the current time.

With reference to the second or the third possible implementation manner of the second aspect, in a fourth possible implementation manner, when determining the weighted value of the first air vent temperature, the weighted value of the first air inlet temperature, the weighted value of the first use rate, the weighted value of the second use rate, and the ambient temperature value, the determining unit is specifically configured to: acquire second air outlet temperature obtained by collecting, at each sampling time point in a period of time previous to the current time, the temperature at the air outlet of the server with the largest temperature value at the current time; acquire third air outlet temperature obtained by collecting, at a specified time point corresponding to each sampling time point, the temperature at the air outlet of the server with the largest temperature value at the current time; acquire second air inlet temperature obtained by collecting, at the specified time point corresponding to each sampling time point, the temperature at the air inlet of the server with the largest temperature value at the current time; acquire a third use rate of the specified hardware device of the server with the largest temperature value at the current time, where the third use rate is specific to each virtual machine in the server with the largest temperature value at the current time, and the third use rate is collected at the specified time point corresponding to each sampling time point; acquire a fourth use rate of the specified hardware device of the server with the largest temperature value at the current time, where the fourth use rate is collected in second specified duration corresponding to each sampling time point; and use the acquired second air outlet temperature as a dependent variable, separately use the acquired third air outlet temperature, second air inlet temperature, third use rate, and fourth use rate as an independent variable, and determine, using the weighted summing manner, the weighted value of the first air outlet temperature, the weighted value of the first air inlet temperature, the weighted value of the first use rate, the weighted value of the second use rate, and the ambient temperature value, where: the specified time point corresponding to any sampling time point is previous to the any sampling time point, and duration between the specified time point corresponding to the any sampling time point and the any sampling time point is equal to duration between the current time and a set prediction time point; and the second specified duration corresponding to the any sampling time point is a period of time that is previous to the specified time point corresponding to the any sampling time point and any duration away from the corresponding specified time point.

With reference to the second or the fourth possible implementation manner of the second aspect, in a fifth possible implementation manner, when selecting the destination server from the other servers that are included in the data center except the server with the largest temperature value at the current time, the selecting unit is specifically configured to: from the other servers that are included in the data center except the server with the largest temperature value at the current time, select by means of screening a server that does not include a virtual machine mutually exclusive with the determined to-be-migrated virtual machine, and/or select by means of screening a server that has an idle resource and meets a resource requirement of the determined to-be-migrated virtual machine; predict a temperature value of each selected server available after the determined to-be-migrated virtual machine is migrated to each selected server; and use a server that is in the selected server and whose corresponding predicted temperature value is less than the largest temperature value as the selected destination server.

With reference to the fifth possible implementation manner of the second aspect, in a sixth possible implementation manner, when using the server that is in the selected server and whose corresponding predicted temperature value is less than the largest temperature value as the selected destination server, the selecting unit is specifically configured to: use any server that is in the selected server and whose temperature value is less than the largest temperature value as the selected destination server.

With reference to the fifth possible implementation manner of the second aspect, in a seventh possible implementation manner, when using the server that is in the selected server and whose corresponding predicted temperature value is less than the largest temperature value as the selected destination server, the selecting unit is specifically configured to: perform the following steps, which are performed on a first server, on each server in the selected servers, where the first server is any server in the selected servers: predicting temperature values of the first server and the server with the largest temperature value at the current time after the determined to-be-migrated virtual machine is migrated to the first server; calculating a difference between a largest temperature value and a smallest temperature value in: the predicted temperature values corresponding to the first server and the server with the largest temperature value at the current time, and measured temperature values obtained by separately measuring other servers in the data center except the first server and the server with the largest temperature value at the current time; and from a calculated difference corresponding to each server in the selected servers, determining a server corresponding to a smallest difference as the selected destination server.

With reference to the seventh possible implementation manner of the second aspect, in an eighth possible implementation manner, when predicting the temperature value of the first server available after the determined to-be-migrated virtual machine is migrated to the first server, the selecting unit is specifically configured to: acquire fourth air outlet temperature obtained by collecting temperature at an air outlet of the first server at the previous sampling time point adjacent to the current time; acquire third air inlet temperature obtained by collecting temperature at an air inlet of the first server at the previous sampling time point adjacent to the current time; acquire a first use rate of the specified hardware device of the server with the largest temperature value at the current time, where the first use rate is specific to the determined to-be-migrated virtual machine, and the first use rate is collected at the previous sampling time point adjacent to the current time; acquire first total storage space of the server with the largest temperature value at the current time, and acquire second total storage space of the first server; acquire a fifth use rate of a specified hardware device of the first server, where the fifth use rate is collected at each sampling time point that is previous to the current time and in the first specified duration; obtain a fifth product by multiplying the acquired fourth air outlet temperature by the determined weighted value of the first air outlet temperature; obtain a sixth product by multiplying the acquired third air inlet temperature by the determined weighted value of the first air inlet temperature; obtain a seventh product by multiplying a product of the acquired first use rate and the determined weighted value of the first use rate by a ratio of the acquired second total storage space to the first total storage space; obtain an eighth product by multiplying the acquired fifth use rate by the determined weighted value of the second use rate; and add the fifth product, the sixth product, the seventh product, the eighth product, and the determined ambient temperature value, and use the sum obtained by the adding as the predicted temperature value of the first server available after the determined to-be-migrated virtual machine is migrated to the first server.

With reference to the seventh possible implementation manner of the second aspect, in a ninth possible implementation manner, when predicting the temperature value of the server with the largest temperature value at the current time after the to-be-migrated virtual machine is migrated from the server with the largest temperature value at the current time to the first server, the selecting unit is specifically configured to: acquire the first air outlet temperature obtained by collecting, at the previous sampling time point adjacent to the current time, the temperature at the air outlet of the server with the largest temperature value at the current time; acquire the first air inlet temperature obtained by collecting, at the previous sampling time point adjacent to the current time, the temperature at the air inlet of the server with the largest temperature value at the current time; acquire the first use rate of the specified hardware device of the server with the largest temperature value at the current time, where the first use rate is specific to the determined to-be-migrated virtual machine, and the first use rate is collected at the previous sampling time point adjacent to the current time; acquire the second use rate of the specified hardware device of the server with the largest temperature value at the current time, where the second use rate is collected at each sampling time point that is previous to the current time and in the first specified duration; obtain the first product by multiplying the acquired first air outlet temperature by the determined weighted value of the first air outlet temperature; obtain the second product by multiplying the acquired first air inlet temperature by the determined weighted value of the first air inlet temperature; obtain the third product by multiplying the acquired first use rate by the determined weighted value of the first use rate; obtain the fourth product by multiplying the acquired second use rate by the determined weighted value of the second use rate; and add the first product, the second product, the third product, the fourth product, and the determined ambient temperature value, and use the sum obtained by the adding as the predicted temperature value of the server with the largest temperature value at the current time after the determined to-be-migrated virtual machine is migrated from the server with the largest temperature value at the current time to the first server.

According to a third aspect, a system for migrating a virtual machine is provided, including a data center, where the data center includes at least one server, and each server in the at least one server includes at least one virtual machine; further including the apparatus for migrating a virtual machine according to the second aspect, or any possible implementation manner in the first possible implementation manner of the second aspect to the ninth possible implementation manner of the second aspect.

Beneficial effects of the present invention are as follows:

In the prior art, a refrigeration manner is generally used at the time of reducing temperature of a data center, and energy consumed in the refrigeration manner is closely related to a largest temperature value of a server in the data center. However, temperature distribution of each server in the current data center is unbalanced, which leads to relatively large energy consumption in a refrigeration process. Therefore, the current refrigeration manner has a defect of relatively large energy consumption. In embodiments of the present invention, a method for migrating a virtual machine is proposed. In this solution, a to-be-migrated virtual machine is determined from a server with a largest temperature value at a current time, and the to-be-migrated virtual machine is migrated to a destination server. Because a temperature value of the destination server available after the to-be-migrated virtual machine is migrated to the destination server is less than the largest temperature value of the server with the largest temperature value at the current time available before the virtual machine is migrated out from the server with the largest temperature value at the current time, a largest temperature value of a server in a data center is reduced; in addition, during refrigeration, more energy is consumed if the largest temperature value is larger, and less energy is consumed if the largest temperature value is smaller. Therefore, this solution reduces energy consumed in a refrigeration process.

### BRIEF DESCRIPTION OF DRAWINGS

FIG. 1 is a detailed flowchart of migrating a virtual machine according to an embodiment of the present invention;

FIG. 2 is an embodiment of migrating a virtual machine according to an embodiment of the present invention;

FIG. 3 is a schematic functional structural diagram of an apparatus for migrating a virtual machine according to an embodiment of the present invention;

FIG. 4 is a schematic diagram of a system for migrating a virtual machine according to an embodiment of the present invention; and

FIG. 5 is a schematic structural diagram of an entity of an apparatus for migrating a virtual machine according to an embodiment of the present invention.

### DESCRIPTION OF EMBODIMENTS

To make the objectives, technical solutions, and advantages of the embodiments of the present invention clearer, the following clearly describes the technical solutions in the embodiments of the present invention with reference to the accompanying drawings in the embodiments of the present invention. The described embodiments are some rather than all of the embodiments of the present invention. All other embodiments obtained by persons of ordinary skill in the art based on the embodiments of the present invention without creative efforts shall fall within the protection scope of the present invention.

The term “and/or” in this specification describes only an association relationship for describing associated objects and represents that three relationships may exist. For example, A and/or B may represent the following three cases: Only A exists, both A and B exist, and only B exists. In addition, the character “/” in this specification generally indicates an “or” relationship between the associated objects.

In embodiments of the present invention, a method for migrating a virtual machine is proposed. In this solution, a to-be-migrated virtual machine is determined from a server with a largest temperature value at a current time, and the to-be-migrated virtual machine is migrated to a destination server. Because a temperature value of the destination server available after the to-be-migrated virtual machine is migrated to the destination server is less than the largest temperature value of the server with the largest temperature value at the current time available before the virtual machine is migrated out from the server with the largest temperature value at the current time, a largest temperature value of a server in a data center is reduced; in addition, during refrigeration, more energy is consumed if the largest temperature value is larger, and less energy is consumed if the largest temperature value is smaller. Therefore, this solution reduces energy consumed in a refrigeration process.

In the following, preferable implementation manners of the present invention are described in detail with reference to the accompanying drawings.

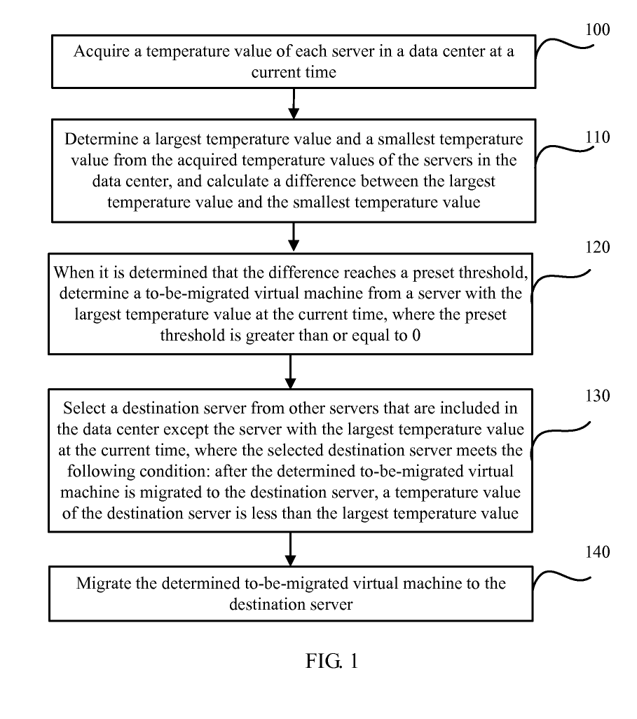

Referring to FIG. 1, an embodiment of the present invention provides a method for migrating a virtual machine. A specific process of the method is as follows:

Step 100: Acquire a temperature value of each server in a data center at a current time.

Step 110: Determine a largest temperature value and a smallest temperature value from the acquired temperature values of the servers in the data center, and calculate a difference between the largest temperature value and the smallest temperature value.

Step 120: When it is determined that the difference reaches a preset threshold, determine a to-be-migrated virtual machine from a server with the largest temperature value at the current time, where the preset threshold is greater than or equal to 0.

Step 130: Select a destination server from other servers that are included in the data center except the server with the largest temperature value at the current time, where the selected destination server meets the following condition: after the determined to-be-migrated virtual machine is migrated to the destination server, a temperature value of the destination server is less than the largest temperature value.

Step 140: Migrate the determined to-be-migrated virtual machine to the destination server.

### Embodiment 1

For example, there are 10 servers in a data center: server 1, server 2, . . . , and server 10.

Step 1: Acquire temperature values of server 1, server 2, . . . , and server 10, and obtain, by means of calculation, a difference 10° C. by a largest temperature value 35° C. minus a smallest temperature value 25° C.

In this step, a server with the largest temperature value 35° C. is server 1.

Step 2: Determine that the difference 10° C. is greater than a preset threshold 4° C., and therefore determine a to-be-migrated virtual machine from 10 virtual machines in server 1.

In this step, there are 10 virtual machines in server 1, and the finally determined to-be-migrated virtual machine is virtual machine 1.

Step 3: Select server 10, from server 2, server 3, . . . , and server 10, as a destination server to which virtual machine 1 is to be migrated.

Step 4: Migrate virtual machine 1 to server 10.

In this embodiment of the present invention, there are multiple manners of determining the to-be-migrated virtual machine from the server with the largest temperature value at the current time. Optionally, the following manner may be used: calculating a value of temperature effect exerted on the server with the largest temperature value at the current time by each virtual machine in the server with the largest temperature value at the current time, where the value of temperature effect exerted on the server with the largest temperature value at the current time by each virtual machine is a temperature value variation of the server with the largest temperature value at the current time when each virtual machine runs in the server with the largest temperature value at the current time; determining a largest value of temperature effect from the calculated values of temperature effect exerted on the server with the largest temperature value at the current time separately by all virtual machines; and using a virtual machine with the determined largest value of temperature effect as the determined to-be-migrated virtual machine.

Embodiment 1 is still used as an example for description.

For example, values of temperature effect exerted on server 1 separately by the 10 virtual machines in server 1 are calculated. When a value of temperature effect exerted on server 1 by virtual machine 1 is the largest, virtual machine 1 is used as the to-be-migrated virtual machine; likewise, when a value of temperature effect exerted on server 1 by virtual machine 2 is the largest, virtual machine 2 is used as the to-be-migrated virtual machine.

The foregoing is merely one manner of determining the to-be-migrated virtual machine from the server with the largest temperature value at the current time. In actual application, there are multiple implementation manners, and details are not described herein again.

In this embodiment of the present invention, there are multiple manners of calculating the value of temperature effect exerted on the server with the largest temperature value at the current time by each virtual machine in the server with the largest temperature value at the current time. Optionally, the following manner may be used: acquiring first air outlet temperature obtained by collecting, at a previous sampling time point adjacent to the current time, temperature at an air outlet of the server with the largest temperature value at the current time, and first air inlet temperature obtained by collecting, at the previous sampling time point adjacent to the current time, temperature at an air inlet of the server with the largest temperature value; acquiring a first use rate of a specified hardware device of the server with the largest temperature value at the current time, where the first use rate is specific to each virtual machine in the server with the largest temperature value at the current time, the first use rate is collected at the previous sampling time point adjacent to the current time, and the specified hardware device has an attribute that heat is generated and the generated heat changes with load of the specified hardware device; acquiring a second use rate of the specified hardware device of the server with the largest temperature value at the current time, where the second use rate is collected at each sampling time point in first specified duration previous to the current time; based on the first air outlet temperature, the first air inlet temperature, the first use rate, and the second use rate that are acquired, and a weighted value of the first air outlet temperature, a weighted value of the first air inlet temperature, a weighted value of the first use rate, a weighted value of the second use rate, and an ambient temperature value that are determined, predicting, using a weighted summing manner, a temperature value of the server with the largest temperature value at the current time available after each virtual machine in the server with the largest temperature value at the current time is migrated out from the server with the largest temperature value at the current time; and performing the following step, which is performed on a first virtual machine, on each virtual machine in the server with the largest temperature value at the current time, where the first virtual machine is any virtual machine in all virtual machines in the server with the largest temperature value at the current time: using an absolute value of a temperature difference between a predicted temperature value and the acquired first air outlet temperature as a value of temperature effect exerted on the server with the largest temperature value at the current time by the first virtual machine, where the predicted temperature value is a temperature value of the server with the largest temperature value at the current time after the first virtual machine is migrated out from the server with the largest temperature value at the current time.

A main idea of the calculating the value of temperature effect exerted on the server with the largest temperature value at the current time by each virtual machine in the server with the largest temperature value at the current time is as follows: acquiring air outlet temperature T1 of the server with the largest temperature value at the current time (that is, temperature of the server with the largest temperature value at the current time available before the foregoing virtual machine A is migrated out from the server with the largest temperature value at the current time), and predicting temperature T2 of the server with the largest temperature value at the current time after virtual machine A is migrated out from the server with the largest temperature value at the current time, where in this process, it is assumed that only virtual machine A is migrated out from the server with the largest temperature value at the current time, and then |T1−T2| is a value of temperature effect exerted on the server with the largest temperature value at the current time by virtual machine A.

The air outlet temperature T1 of the server with the largest temperature value at the current time may be collected; the temperature T2 may be predicted according to the air outlet temperature, the air inlet temperature, the first use rate, and the second use rate that are collected, where the temperature T2 is temperature of the server with the largest temperature value at the current time after virtual machine A is migrated out from the server with the largest temperature value at the current time.

In this embodiment of the present invention, there are multiple manners of predicting the temperature value of the server with the largest temperature value at the current time available after each virtual machine in the server with the largest temperature value at the current time is migrated out from the server with the largest temperature value at the current time. Optionally, the following manner may be used: performing the following steps, which are performed on the first virtual machine, on each virtual machine in the server with the largest temperature value at the current time: obtaining a first product by multiplying the acquired first air outlet temperature by the determined weighted value of the first air outlet temperature; obtaining a second product by multiplying the acquired first air inlet temperature by the determined weighted value of the first air inlet temperature; obtaining a third product by multiplying the acquired first use rate by the determined weighted value of the first use rate; obtaining a fourth product by multiplying the acquired second use rate by the determined weighted value of the second use rate; and adding the first product, the second product, the third product, the fourth product, and the determined ambient temperature value, and using the sum obtained by the adding as the temperature value of the server with the largest temperature value at the current time after the first virtual machine is migrated out from the server with the largest temperature value at the current time.

For example, at the time of predicting temperature T of the server with the largest temperature value at the current time available after virtual machine A is migrated out from server 1 with the largest temperature value at the current time, specifically formula 1 may be used to perform calculation (if the temperature T of server 1 after virtual machine 1 is migrated out from server 1 is to be calculated):

T=T0+C1×X1+C2×X2++C3×X3+C4×X4 (Formula 1)

T0 is an ambient temperature value; X1 is first air outlet temperature obtained by collecting temperature at an air outlet of server 1 at the previous sampling time point adjacent to the current time; X2 is first air inlet temperature obtained by collecting temperature at an air inlet of server 1 at the previous sampling time point adjacent to the current time; X3 is a first use rate of a specified hardware device of server 1, where the first use rate is specific to virtual machine A, and the first use rate is collected at the previous sampling time point adjacent to the current time; X4 is a second use rate of the specified hardware device of server 1, where the second use rate is collected at each sampling time point that is previous to the current time and in the first specified duration; and C1 is a determined weighted value of the first air outlet temperature, C2 is a determined weighted value of the first air inlet temperature, C3 is a determined weighted value of the first use rate, and C4 is a determined weighted value of the second use rate.

In this embodiment of the present invention, there are multiple manners of determining the weighted value of the first air vent temperature, the weighted value of the first air inlet temperature, the weighted value of the first use rate, the weighted value of the second use rate, and the ambient temperature value. Optionally, the following manner may be used: acquiring second air outlet temperature obtained by collecting, at each sampling time point in a period of time previous to the current time, the temperature at the air outlet of the server with the largest temperature value at the current time; acquiring third air outlet temperature obtained by collecting, at a specified time point corresponding to each sampling time point, the temperature at the air outlet of the server with the largest temperature value at the current time; acquiring second air inlet temperature obtained by collecting, at the specified time point corresponding to each sampling time point, the temperature at the air inlet of the server with the largest temperature value at the current time; acquiring a third use rate of the specified hardware device of the server with the largest temperature value at the current time, where the third use rate is specific to each virtual machine in the server with the largest temperature value at the current time, and the third use rate is collected at the specified time point corresponding to each sampling time point; acquiring a fourth use rate of the specified hardware device of the server with the largest temperature value at the current time, where the fourth use rate is collected in second specified duration corresponding to each sampling time point; and using the acquired second air outlet temperature as a dependent variable, separately using the acquired third air outlet temperature, second air inlet temperature, third use rate, and fourth use rate as an independent variable, and determining, using the weighted summing manner, the weighted value of the first air outlet temperature, the weighted value of the first air inlet temperature, the weighted value of the first use rate, the weighted value of the second use rate, and the ambient temperature value, where: the specified time point corresponding to any sampling time point is previous to the any sampling time point, and duration between the specified time point corresponding to the any sampling time point and the any sampling time point is equal to duration between the current time and a set prediction time point; and the second specified duration corresponding to the any sampling time point is a period of time that is previous to the specified time point corresponding to the any sampling time point and any duration away from the corresponding specified time point.

The foregoing determining process may also be implemented using formula 1. For any sampling time point in a period of time previous to the current time, formula 1 may be used to construct an equation, and a specific process is as follows (the server with the largest temperature value at the current time is server 1, the virtual machine is virtual machine A, and a sampling time point is sampling time point 1, where there are totally 10 sampling time points):

T=T0+C1×X5+C2×X6++C3×X7+C4×X8

T0 is the ambient temperature value; T is acquired second air outlet temperature obtained by collecting the temperature at the air outlet of server 1 at sampling time point 1; X5 is acquired third air outlet temperature obtained by collecting the temperature at the air outlet of server 1 at a specified time point corresponding to sampling time point 1; X6 is acquired second air inlet temperature obtained by collecting the temperature at the air inlet of server 1 at the specified time point corresponding to sampling time point 1; X7 is an acquired third use rate of the specified hardware device of server 1 by virtual machine A in server 1, where the third use rate is collected at the specified time point corresponding to sampling time point 1; X8 is an acquired fourth use rate of the specified hardware device of server 1, where the fourth use rate is collected in second specified duration corresponding to sampling time point 1; and C1 is the weighted value of the first air outlet temperature, C2 is the weighted value of the first air inlet temperature, C3 is the weighted value of the first use rate, and C4 is the weighted value of the second use rate.

The foregoing merely describes an equation constructed according to data acquired at sampling time point 1; likewise, equations may be separately constructed for data acquired at sampling time points 2 to 9; and finally 10 equations are obtained. Then, an equation set consisting of these 10 equations is solved to obtain C1, C2, C3, and C4.

In this embodiment of the present invention, when the equation set is solved, a least square method may be specifically used to solve the equation set.

In this embodiment of the present invention, there are multiple manners of selecting the destination server from the other servers that are included in the data center except the server with the largest temperature value at the current time. Optionally, the following manner may be used: from the other servers that are included in the data center except the server with the largest temperature value at the current time, selecting by means of screening a server that does not include a virtual machine mutually exclusive with the determined to-be-migrated virtual machine, and/or selecting by means of screening a server that has an idle resource and meets a resource requirement of the determined to-be-migrated virtual machine; predicting a temperature value of each selected server available after the determined to-be-migrated virtual machine is migrated to each selected server; and using a server that is in the selected server and whose corresponding predicted temperature value is less than the largest temperature value as the selected destination server.

For example, there are 10 servers in the data center, and the server with the largest temperature value at the current time is server 1. Then, server 6, server 7, server 8, server 9, and server 10 are selected from server 2, server 3, . . . , and server 10; and then temperature values of server 6, server 7, server 8, server 9, and server 10 after the determined to-be-migrated virtual machine is separately migrated to server 6, server 7, server 8, server 9, and server 10 are separately predicted, and a server that is in the selected server and whose corresponding predicted temperature value is less than the largest temperature value is used as the selected destination server.

In this embodiment of the present invention, there are multiple manners of using the server that is in the selected server and whose corresponding predicted temperature value is less than the largest temperature value as the selected destination server. Optionally, the following manner may be used: using any server that is in the selected server and whose temperature value is less than the largest temperature value as the selected destination server.

For example, there are 10 servers in the data center, and the server with the largest temperature value at the current time is server 1. Then, server 6, server 7, server 8, server 9, and server 10 are selected from server 2, server 3, . . . , and server 10; and then temperature values of server 6, server 7, server 8, server 9, and server 10 after the determined to-be-migrated virtual machine is separately migrated to server 6, server 7, server 8, server 9, and server 10 are separately predicted, and a server that is in the selected server and whose corresponding predicted temperature value is less than the largest temperature value is used as the selected destination server.

To reduce the number of times of migrating a virtual machine in a process of balancing temperature of servers in the data center, and to reduce resource consumption, further, the following manner may be further used: performing the following steps, which are performed on a first server, on each server in the selected servers, where the first server is any server in the selected servers: predicting temperature values of the first server and the server with the largest temperature value at the current time after the determined to-be-migrated virtual machine is migrated to the first server; calculating a difference between a largest temperature value and a smallest temperature value in: the predicted temperature values corresponding to the first server and the server with the largest temperature value at the current time, and measured temperature values obtained by separately measuring other servers in the data center except the first server and the server with the largest temperature value at the current time; and from a calculated difference corresponding to each server in the selected servers, determining a server corresponding to a smallest difference as the selected destination server.

For example, there are 10 servers in the data center, and five servers are selected: server 6, server 7, server 8, server 9, and server 10, and then a difference between a largest temperature value and a smallest temperature value in the 10 servers after it is assumed that the to-be-migrated virtual machine 1 is separately migrated to any server in the foregoing five servers. For example, it is assumed that after virtual machine 1 is migrated to server 6, the difference between the largest temperature value and the smallest temperature value in the 10 servers is 10° C.; it is assumed that after virtual machine 1 is migrated to server 7, the difference between the largest temperature value and the smallest temperature value in the 10 servers is 8° C.; it is assumed that after virtual machine 1 is migrated to server 8, the difference between the largest temperature value and the smallest temperature value in the 10 servers is 4° C.; it is assumed that after virtual machine 1 is migrated to server 9, the difference between the largest temperature value and the smallest temperature value in the 10 servers is 9° C.; it is assumed that after virtual machine 1 is migrated to server 10, the difference between the largest temperature value and the smallest temperature value in the 10 servers is 2° C., where when the smallest difference is 2° C., it is assumed that virtual machine 1 is migrated to server 10, and in this case, server 10 is used as the destination server.

In this embodiment of the present invention, there are multiple manners of predicting the temperature value of the first server available after the determined to-be-migrated virtual machine is migrated to the first server. Optionally, the following manner may be used: acquiring fourth air outlet temperature obtained by collecting temperature at an air outlet of the first server at the previous sampling time point adjacent to the current time; acquiring third air inlet temperature obtained by collecting temperature at an air inlet of the first server at the previous sampling time point adjacent to the current time; acquiring a first use rate of the specified hardware device of the server with the largest temperature value at the current time, where the first use rate is specific to the determined to-be-migrated virtual machine, and the first use rate is collected at the previous sampling time point adjacent to the current time; acquiring first total storage space of the server with the largest temperature value at the current time, and acquiring second total storage space of the first server; acquiring a fifth use rate of a specified hardware device of the first server, where the fifth use rate is collected at each sampling time point that is previous to the current time and in the first specified duration; obtaining a fifth product by multiplying the acquired fourth air outlet temperature by the determined weighted value of the first air outlet temperature; obtaining a sixth product by multiplying the acquired third air inlet temperature by the determined weighted value of the first air inlet temperature; obtaining a seventh product by multiplying a product of the acquired first use rate and the determined weighted value of the first use rate by a ratio of the acquired second total storage space to the first total storage space; obtaining an eighth product by multiplying the acquired fifth use rate by the determined weighted value of the second use rate; and adding the fifth product, the sixth product, the seventh product, the eighth product, and the determined ambient temperature value, and using the sum obtained by the adding as the predicted temperature value of the first server available after the determined to-be-migrated virtual machine is migrated to the first server.

In implementation, the predicted temperature value of the first server may be specifically calculated using formula 1. For example, the server with the largest temperature value at the current time is server 1, and the first server is server 2:

T=T0+C1×X9+C2×X10++C3×X11×A1/A2+C4×X12

In this case, T0 is the ambient temperature value; X9 is fourth air outlet temperature obtained by collecting temperature at an air outlet of server 2 at the previous sampling time point adjacent to the current time; X10 is third air inlet temperature obtained by collecting temperature at an air inlet of server 2 at the previous sampling time point adjacent to the current time; X11 is a first use rate of the specified hardware device of server 1 by the determined to-be-migrated virtual machine, where the first use rate is collected at the previous sampling time point adjacent to the current time; X12 is a fifth use rate of a specified hardware device of server 2, where the fifth use rate is collected at each sampling time point that is previous to the current time and in the first specified duration; C1 is the weighted value of the first air outlet temperature, C2 is the weighted value of the first air inlet temperature, C3 is the weighted value of the first use rate, and C4 is the weighted value of the second use rate; and A1 is second total storage space of server 2, and A2 is first total storage space of server 1.

In this embodiment of the present invention, there are multiple manners of predicting the temperature value of the server with the largest temperature value at the current time available after the determined to-be-migrated virtual machine is migrated from the server with the largest temperature value at the current time to the first server. Optionally, the following manner may be used: acquiring the first air outlet temperature obtained by collecting, at the previous sampling time point adjacent to the current time, the temperature at the air outlet of the server with the largest temperature value at the current time; acquiring the first air inlet temperature obtained by collecting, at the previous sampling time point adjacent to the current time, the temperature at the air inlet of the server with the largest temperature value at the current time; acquiring the first use rate of the specified hardware device of the server with the largest temperature value at the current time, where the first use rate is specific to the determined to-be-migrated virtual machine, and the first use rate is collected at the previous sampling time point adjacent to the current time; acquiring the second use rate of the specified hardware device of the server with the largest temperature value at the current time, where the second use rate is collected at each sampling time point that is previous to the current time and in the first specified duration; obtaining the first product by multiplying the acquired first air outlet temperature by the determined weighted value of the first air outlet temperature; obtaining the second product by multiplying the acquired first air inlet temperature by the determined weighted value of the first air inlet temperature; obtaining the third product by multiplying the acquired first use rate by the determined weighted value of the first use rate; obtaining the fourth product by multiplying the acquired second use rate by the determined weighted value of the second use rate; and adding the first product, the second product, the third product, the fourth product, and the determined ambient temperature value, and using the sum obtained by the adding as the predicted temperature value of the server with the largest temperature value at the current time after the determined to-be-migrated virtual machine is migrated from the server with the largest temperature value at the current time to the first server.

In this embodiment of the present invention, the hardware device includes a central processing unit, a memory, a disk, and a network; likewise, the first use rate of the hardware device includes a first use rate of the central processing unit, a first use rate of the memory, a first use rate of the disk, and a first use rate of the network.

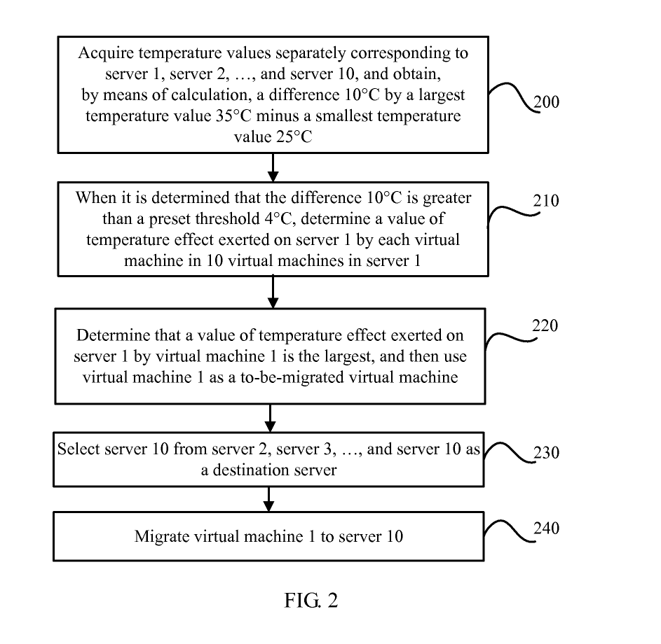

To better understand this embodiment of the present invention, a specific application scenario is provided in the following, and a process of migrating a virtual machine is further described in detail, which is shown in FIG. 2.

There are 10 servers in a data center: server 1, server 2, . . . , and server 10.

Step 200: Acquire respective temperature values of server 1, server 2, . . . , and server 10, and obtain, by means of calculation, a difference 10° C. by a largest temperature value 35° C. minus a smallest temperature value 25° C.

In this step, a server with the largest temperature value 35° C. is server 1.

Step 210: When it is determined that the difference 10° C. is greater than a preset threshold 4° C., determine a value of temperature effect exerted on server 1 by each virtual machine in 10 virtual machines in server 1.

Step 220: Determine that a value of temperature effect exerted on server 1 by virtual machine 1 is the largest, and then use virtual machine 1 as a to-be-migrated virtual machine.

Step 230: Select server 10 from server 2, server 3, . . . , and server 10 as a destination server.

Step 240: Migrate virtual machine 1 to server 10.

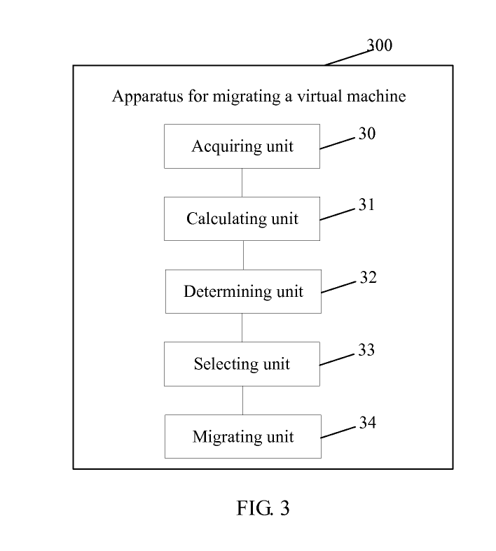

Based on the foregoing technical solution and referring to FIG. 3, an embodiment of the present invention provides an apparatus 300 for migrating a virtual machine, and the apparatus 300 for migrating a virtual machine includes an acquiring unit 30, a calculating unit 31, a determining unit 32, a selecting unit 33, and a migrating unit 34.

The acquiring unit 30 is configured to acquire a temperature value of each server in a data center at a current time.

The calculating unit 31 is configured to: determine a largest temperature value and a smallest temperature value from the acquired temperature values of the servers in the data center, and calculate a difference between the largest temperature value and the smallest temperature value.

The determining unit 32 is configured to determine a to-be-migrated virtual machine from a server with the largest temperature value at the current time when it is determined that the difference reaches a preset threshold, where the preset threshold is greater than or equal to 0.

The selecting unit 33 is configured to select a destination server from other servers that are included in the data center except the server with the largest temperature value at the current time, where the selected destination server meets the following condition: after the determined to-be-migrated virtual machine is migrated to the destination server, a temperature value of the destination server is less than the largest temperature value.

The migrating unit 34 is configured to migrate the determined to-be-migrated virtual machine to the destination server.

In this embodiment of the present invention, optionally, when determining the to-be-migrated virtual machine from the server with the largest temperature value at the current time, the determining unit 32 is specifically configured to: calculate a value of temperature effect exerted on the server with the largest temperature value at the current time by each virtual machine in the server with the largest temperature value at the current time, where the value of temperature effect exerted on the server with the largest temperature value at the current time by each virtual machine is a temperature value variation of the server with the largest temperature value at the current time when each virtual machine runs in the server with the largest temperature value at the current time; determine a largest value of temperature effect from the calculated values of temperature effect exerted on the server with the largest temperature value at the current time separately by all virtual machines; and use a virtual machine with the determined largest value of temperature effect as the determined to-be-migrated virtual machine.

In this embodiment of the present invention, optionally, when calculating the value of temperature effect exerted on the server with the largest temperature value at the current time by each virtual machine in the server with the largest temperature value at the current time, the determining unit 32 is specifically configured to: acquire first air outlet temperature obtained by collecting, at a previous sampling time point adjacent to the current time, temperature at an air outlet of the server with the largest temperature value at the current time, and first air inlet temperature obtained by collecting, at the previous sampling time point adjacent to the current time, temperature at an air inlet of the server with the largest temperature value; acquire a first use rate of a specified hardware device of the server with the largest temperature value at the current time, where the first use rate is specific to each virtual machine in the server with the largest temperature value at the current time, the first use rate is collected at the previous sampling time point adjacent to the current time, and the specified hardware device has an attribute that heat is generated and the generated heat changes with load of the specified hardware device; acquire a second use rate of the specified hardware device of the server with the largest temperature value at the current time, where the second use rate is collected at each sampling time point in first specified duration previous to the current time; based on the first air outlet temperature, the first air inlet temperature, the first use rate, and the second use rate that are acquired, and a weighted value of the first air outlet temperature, a weighted value of the first air inlet temperature, a weighted value of the first use rate, a weighted value of the second use rate, and an ambient temperature value that are determined, predict, using a weighted summing manner, a temperature value of the server with the largest temperature value at the current time available after each virtual machine in the server with the largest temperature value at the current time is migrated out from the server with the largest temperature value at the current time; and perform the following step, which is performed on a first virtual machine, on each virtual machine in the server with the largest temperature value at the current time, where the first virtual machine is any virtual machine in all virtual machines in the server with the largest temperature value at the current time: using an absolute value of a temperature difference between a predicted temperature value and the acquired first air outlet temperature as a value of temperature effect exerted on the server with the largest temperature value at the current time by the first virtual machine, where the predicted temperature value is a temperature value of the server with the largest temperature value at the current time after the first virtual machine is migrated out from the server with the largest temperature value at the current time.

In this embodiment of the present invention, optionally, when predicting, using the weighted summing manner, the temperature value of the server with the largest temperature value at the current time available after each virtual machine in the server with the largest temperature value at the current time is migrated out from the server with the largest temperature value at the current time, the determining unit 32 is specifically configured to: perform the following steps, which are performed on the first virtual machine, on each virtual machine in the server with the largest temperature value at the current time: obtaining a first product by multiplying the acquired first air outlet temperature by the determined weighted value of the first air outlet temperature; obtaining a second product by multiplying the acquired first air inlet temperature by the determined weighted value of the first air inlet temperature; obtaining a third product by multiplying the acquired first use rate by the determined weighted value of the first use rate; obtaining a fourth product by multiplying the acquired second use rate by the determined weighted value of the second use rate; and adding the first product, the second product, the third product, the fourth product, and the determined ambient temperature value, and using the sum obtained by the adding as the temperature value of the server with the largest temperature value at the current time after the first virtual machine is migrated out from the server with the largest temperature value at the current time.

In this embodiment of the present invention, optionally, when determining the weighted value of the first air vent temperature, the weighted value of the first air inlet temperature, the weighted value of the first use rate, the weighted value of the second use rate, and the ambient temperature value, the determining unit 32 is specifically configured to: acquire second air outlet temperature obtained by collecting, at each sampling time point in a period of time previous to the current time, the temperature at the air outlet of the server with the largest temperature value at the current time; acquire third air outlet temperature obtained by collecting, at a specified time point corresponding to each sampling time point, the temperature at the air outlet of the server with the largest temperature value at the current time; acquire second air inlet temperature obtained by collecting, at the specified time point corresponding to each sampling time point, the temperature at the air inlet of the server with the largest temperature value at the current time; acquire a third use rate of the specified hardware device of the server with the largest temperature value at the current time, where the third use rate is specific to each virtual machine in the server with the largest temperature value at the current time, and the third use rate is collected at the specified time point corresponding to each sampling time point; acquire a fourth use rate of the specified hardware device of the server with the largest temperature value at the current time, where the fourth use rate is collected in second specified duration corresponding to each sampling time point; and use the acquired second air outlet temperature as a dependent variable, separately use the acquired third air outlet temperature, second air inlet temperature, third use rate, and fourth use rate as an independent variable, and determine, using the weighted summing manner, the weighted value of the first air outlet temperature, the weighted value of the first air inlet temperature, the weighted value of the first use rate, the weighted value of the second use rate, and the ambient temperature value, where: the specified time point corresponding to any sampling time point is previous to the any sampling time point, and duration between the specified time point corresponding to the any sampling time point and the any sampling time point is equal to duration between the current time and a set prediction time point; and the second specified duration corresponding to the any sampling time point is a period of time that is previous to the specified time point corresponding to the any sampling time point and any duration away from the corresponding specified time point.

In this embodiment of the present invention, optionally, when selecting the destination server from the other servers that are included in the data center except the server with the largest temperature value at the current time, the selecting unit 33 is specifically configured to: from the other servers that are included in the data center except the server with the largest temperature value at the current time, select by means of screening a server that does not include a virtual machine mutually exclusive with the determined to-be-migrated virtual machine, and/or select by means of screening a server that has an idle resource and meets a resource requirement of the determined to-be-migrated virtual machine; predict a temperature value of each selected server available after the determined to-be-migrated virtual machine is migrated to each selected server; and use a server that is in the selected server and whose corresponding predicted temperature value is less than the largest temperature value as the selected destination server.

In this embodiment of the present invention, optionally, when using the server that is in the selected server and whose corresponding predicted temperature value is less than the largest temperature value as the selected destination server, the selecting unit 33 is specifically configured to: use any server that is in the selected server and whose temperature value is less than the largest temperature value as the selected destination server.

In this embodiment of the present invention, optionally, when using the server that is in the selected server and whose corresponding predicted temperature value is less than the largest temperature value as the selected destination server, the selecting unit 33 is specifically configured to: perform the following steps, which are performed on a first server, on each server in the selected servers, where the first server is any server in the selected servers: predicting temperature values of the first server and the server with the largest temperature value at the current time after the determined to-be-migrated virtual machine is migrated to the first server; calculating a difference between a largest temperature value and a smallest temperature value in: the predicted temperature values corresponding to the first server and the server with the largest temperature value at the current time, and measured temperature values obtained by separately measuring other servers in the data center except the first server and the server with the largest temperature value at the current time; and from a calculated difference corresponding to each server in the selected servers, determining a server corresponding to a smallest difference as the selected destination server.

In this embodiment of the present invention, optionally, when predicting the temperature value of the first server available after the determined to-be-migrated virtual machine is migrated to the first server, the selecting unit 33 is specifically configured to: acquire fourth air outlet temperature obtained by collecting temperature at an air outlet of the first server at the previous sampling time point adjacent to the current time; acquire third air inlet temperature obtained by collecting temperature at an air inlet of the first server at the previous sampling time point adjacent to the current time; acquire a first use rate of the specified hardware device of the server with the largest temperature value at the current time, where the first use rate is specific to the determined to-be-migrated virtual machine, and the first use rate is collected at the previous sampling time point adjacent to the current time; acquire first total storage space of the server with the largest temperature value at the current time, and acquire second total storage space of the first server; acquire a fifth use rate of a specified hardware device of the first server, where the fifth use rate is collected at each sampling time point that is previous to the current time and in the first specified duration; obtain a fifth product by multiplying the acquired fourth air outlet temperature by the determined weighted value of the first air outlet temperature; obtain a sixth product by multiplying the acquired third air inlet temperature by the determined weighted value of the first air inlet temperature; obtain a seventh product by multiplying a product of the acquired first use rate and the determined weighted value of the first use rate by a ratio of the acquired second total storage space to the first total storage space; obtain an eighth product by multiplying the acquired fifth use rate by the determined weighted value of the second use rate; and add the fifth product, the sixth product, the seventh product, the eighth product, and the determined ambient temperature value, and use the sum obtained by the adding as the predicted temperature value of the first server available after the determined to-be-migrated virtual machine is migrated to the first server.

In this embodiment of the present invention, optionally, when predicting the temperature value of the server with the largest temperature value at the current time after the determined to-be-migrated virtual machine is migrated from the server with the largest temperature value at the current time to the first server, the selecting unit 33 is specifically configured to: acquire the first air outlet temperature obtained by collecting, at the previous sampling time point adjacent to the current time, the temperature at the air outlet of the server with the largest temperature value at the current time; acquire the first air inlet temperature obtained by collecting, at the previous sampling time point adjacent to the current time, the temperature at the air inlet of the server with the largest temperature value at the current time; acquire the first use rate of the specified hardware device of the server with the largest temperature value at the current time, where the first use rate is specific to the determined to-be-migrated virtual machine, and the first use rate is collected at the previous sampling time point adjacent to the current time; acquire the second use rate of the specified hardware device of the server with the largest temperature value at the current time, where the second use rate is collected at each sampling time point that is previous to the current time and in the first specified duration; obtain the first product by multiplying the acquired first air outlet temperature by the determined weighted value of the first air outlet temperature; obtain the second product by multiplying the acquired first air inlet temperature by the determined weighted value of the first air inlet temperature; obtain the third product by multiplying the acquired first use rate by the determined weighted value of the first use rate; obtain the fourth product by multiplying the acquired second use rate by the determined weighted value of the second use rate; and add the first product, the second product, the third product, the fourth product, and the determined ambient temperature value, and use the sum obtained by the adding as the predicted temperature value of the server with the largest temperature value at the current time after the determined to-be-migrated virtual machine is migrated from the server with the largest temperature value at the current time to the first server.

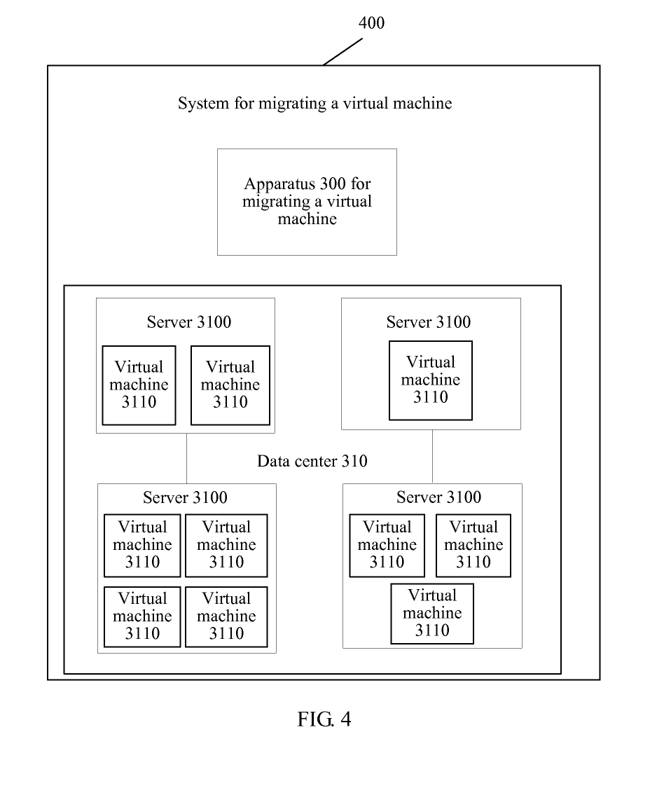

Based on the foregoing technical solution and referring to FIG. 4, an embodiment of the present invention provides a system 400 for migrating a virtual machine, including a data center 310, where the data center 310 includes at least one server 3100, and each server 3100 in the at least one server 3100 includes at least one virtual machine 3110; and further including the apparatus 300 for migrating a virtual machine shown in FIG. 3, where different virtual machines 3110 in each server 3100 are virtual processing units that are configured to process different threads and separately obtained by logically dividing processing resources in server 3100. When one server 3100 includes multiple virtual machines 3110, different virtual machines 3110 may separately process different threads, so that the server 3110 performs multithread processing.

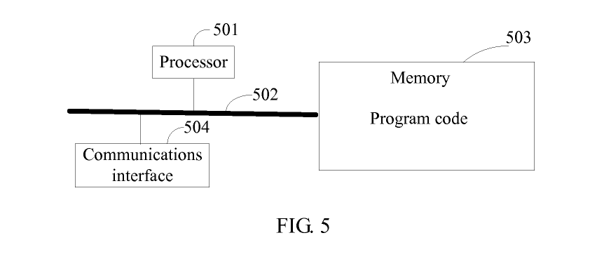

As shown in FIG. 5, FIG. 5 is an entity diagram of an apparatus for migrating a virtual machine according to an embodiment of the present invention. The apparatus for migrating a virtual machine includes at least one processor 501, a communications bus 502, a memory 503, and at least one communications interface 504.

The communications bus 502 is configured to implement connections and communication among the foregoing components, and the communications interface 504 is configured to connect to and communicate with an external device.

The memory 503 is configured to store program code that needs to be executed, and the processor 501 may invoke, using the communications bus 502, program code that is stored in the memory 503 and has a function of migrating a virtual machine. When invoking the program code stored in the memory 503, the processor 501 performs the following operations: acquiring a temperature value of each server in a data center at a current time; determining a largest temperature value and a smallest temperature value from the acquired temperature values of the servers in the data center, and calculating a difference between the largest temperature value and the smallest temperature value; when it is determined that the difference reaches a preset threshold, determining a to-be-migrated virtual machine from a server with the largest temperature value at the current time, where the preset threshold is greater than or equal to 0; selecting a destination server from other servers that are included in the data center except the server with the largest temperature value at the current time, where the selected destination server meets the following condition: after the determined to-be-migrated virtual machine is migrated to the destination server, a temperature value of the destination server is less than the largest temperature value; and migrating the determined to-be-migrated virtual machine to the destination server.

When invoking the program code stored in the memory 503, the processor 501 may further perform the following operations: calculating a value of temperature effect exerted on the server with the largest temperature value at the current time by each virtual machine in the server with the largest temperature value at the current time, where the value of temperature effect exerted on the server with the largest temperature value at the current time by each virtual machine is a temperature value variation of the server with the largest temperature value at the current time when each virtual machine runs in the server with the largest temperature value at the current time; determining a largest value of temperature effect from the calculated values of temperature effect exerted on the server with the largest temperature value at the current time separately by all virtual machines; and using a virtual machine with the determined largest value of temperature effect as the determined to-be-migrated virtual machine.

When invoking the program code stored in the memory 503, the processor 501 may further perform the following operations: from the other servers that are included in the data center except the server with the largest temperature value at the current time, selecting by means of screening a server that does not include a virtual machine mutually exclusive with the determined to-be-migrated virtual machine, and/or selecting by means of screening a server that has an idle resource and meets a resource requirement of the determined to-be-migrated virtual machine; predicting a temperature value of each selected server available after the determined to-be-migrated virtual machine is migrated to each selected server; and using a server that is in the selected server and whose corresponding predicted temperature value is less than the largest temperature value as the selected destination server.

In conclusion, in the embodiment of the present invention, a method for migrating a virtual machine is provided. The method includes: acquiring a temperature value of each server in a data center at a current time; determining a largest temperature value and a smallest temperature value from the acquired temperature values of the servers in the data center, and calculating a difference between the largest temperature value and the smallest temperature value; when it is determined that the difference reaches a preset threshold, determining a to-be-migrated virtual machine from a server with the largest temperature value at the current time, where the preset threshold is greater than or equal to 0; selecting a destination server from other servers that are included in the data center except the server with the largest temperature value at the current time, where the selected destination server meets the following condition: after the determined to-be-migrated virtual machine is migrated to the destination server, a temperature value of the destination server is less than the largest temperature value; and migrating the determined to-be-migrated virtual machine to the destination server. In this solution, the to-be-migrated virtual machine is determined from the server with the largest temperature value at the current time, and the to-be-migrated virtual machine is migrated to the destination server. Because a temperature value of the destination server available after the to-be-migrated virtual machine is migrated to the destination server is less than the largest temperature value of the server with the largest temperature value at the current time available before the virtual machine is migrated out from the server with the largest temperature value at the current time, a largest temperature value of a server in the data center is reduced; in addition, during refrigeration, more energy is consumed if the largest temperature value is larger, and less energy is consumed if the largest temperature value is smaller. Therefore, this solution reduces energy consumed in a refrigeration process.

The present invention is described with reference to the flowcharts and/or block diagrams of the method, the device (system), and the computer program product according to the embodiments of the present invention. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a function in one or more processes in the flowcharts and/or in one or more blocks in the block diagrams.

These computer program instructions may also be stored in a computer readable memory that can instruct the computer or any other programmable data processing device to work in a specific manner, so that the instructions stored in the computer readable memory generate an artifact that includes an instruction apparatus. The instruction apparatus implements a function in one or more processes in the flowcharts and/or in one or more blocks in the block diagrams.

These computer program instructions may also be loaded onto a computer or another programmable data processing device, so that a series of operations and steps are performed on the computer or the another programmable device, thereby generating computer-implemented processing. Therefore, the instructions executed on the computer or the other programmable device provide steps for implementing a function in one or more processes in the flowcharts and/or in one or more blocks in the block diagrams.

Although preferred embodiments of the present invention have been described, persons skilled in the art can make changes and modifications to these embodiments once they learn the basic inventive concept. Therefore, the following claims are intended to be construed as to cover the preferred embodiments and all changes and modifications falling within the scope of the present invention.

Obviously, persons skilled in the art can make various modifications and variations to the embodiments of the present invention without departing from the spirit and scope of the embodiments of the present invention. In this way, the present invention is intended to cover these modifications and variations provided that these modifications and variations to the embodiments of the present invention fall within the scope of claims of the present invention and equivalent technologies of the claims.

1. A method for migrating a virtual machine, comprising:
acquiring a temperature value of each server in a data center at a current time;
determining a largest temperature value and a smallest temperature value from the acquired temperature values of the servers in the data center;
calculating a difference between the largest temperature value and the smallest temperature value;
determining a to-be-migrated virtual machine from a server with the largest temperature value at the current time when it is determined that the difference reaches a preset threshold, wherein the preset threshold is greater than or equal to 0;
selecting a destination server from other servers that are part of the data center except the server with the largest temperature value at the current time, wherein the selected destination server meets the following condition: a temperature value of the destination server is less than the largest temperature value after the determined to-be-migrated virtual machine is migrated to the destination server; and
migrating the determined to-be-migrated virtual machine to the destination server.

2. The method according to claim 1, wherein determining the to-be-migrated virtual machine from server with the largest temperature value at the current time comprises:
calculating a value of temperature effect exerted on the server with the largest temperature value at the current time by each virtual machine in the server with the largest temperature value at the current time, wherein the value of temperature effect exerted on the server with the largest temperature value at the current time by each virtual machine is a temperature value variation of the server with the largest temperature value at the current time when each virtual machine runs in the server with the largest temperature value at the current time;
determining a largest value of temperature effect from the calculated values of temperature effect exerted on the server with the largest temperature value at the current time separately by all virtual machines; and
using a virtual machine with the determined largest value of temperature effect as the determined to-be-migrated virtual machine.

3. The method according to claim 2, wherein calculating the value of temperature effect exerted on the server with the largest temperature value at the current time by each virtual machine in the server with the largest temperature value at the current time comprises:
acquiring a first air outlet temperature obtained by collecting, at a previous sampling time point adjacent to the current time, a temperature at an air outlet of the server with the largest temperature value at the current time;
acquiring a first air inlet temperature obtained by collecting, at the previous sampling time point adjacent to the current time, a temperature at an air inlet of the server with the largest temperature value;
acquiring a first use rate of a specified hardware device of the server with the largest temperature value at the current time, wherein the first use rate refers to a use rate of the specified hardware device by each virtual machine in the server with the largest temperature value at the current time, wherein the first use rate is collected at the previous sampling time point adjacent to the current time, and wherein the specified hardware device has an attribute that heat is generated and the generated heat changes with load of the specified hardware device;
acquiring a second use rate of the specified hardware device of the server with the largest temperature value at the current time, wherein the second use rate is collected at each sampling time point that is previous to the current time and in a first specified duration away from the current time;
based on the first air outlet temperature, the first air inlet temperature, the first use rate, and the second use rate that are acquired, and a weighted value of the first air outlet temperature, a weighted value of the first air inlet temperature, a weighted value of the first use rate, a weighted value of the second use rate, and an ambient temperature value that are determined, predicting, using a weighted summing manner, a temperature value of the server with the largest temperature value at the current time available after each virtual machine in the server with the largest temperature value at the current time is migrated out from the server with the largest temperature value at the current time; and
performing the following step, which is performed on a first virtual machine, on each virtual machine in the server with the largest temperature value at the current time, wherein the first virtual machine is any virtual machine in all virtual machines in the server with the largest temperature value at the current time: using an absolute value of a temperature difference between a predicted temperature value and the acquired first air outlet temperature as a value of temperature effect exerted on the server with the largest temperature value at the current time by the first virtual machine, wherein the predicted temperature value is a temperature value of the server with the largest temperature value at the current time after the first virtual machine is migrated out from the server with the largest temperature value at the current time.

4. The method according to claim 3, wherein predicting, using the weighted summing manner, the temperature value of the server with the largest temperature value at the current time available after each virtual machine in the server with the largest temperature value at the current time is migrated out from the server with the largest temperature value at the current time comprises performing the following steps, which are performed on the first virtual machine, on each virtual machine in the server with the largest temperature value at the current time:
obtaining a first product by multiplying the acquired first air outlet temperature by the determined weighted value of the first air outlet temperature;
obtaining a second product by multiplying the acquired first air inlet temperature by the determined weighted value of the first air inlet temperature;
obtaining a third product by multiplying the acquired first use rate by the determined weighted value of the first use rate;
obtaining a fourth product by multiplying the acquired second use rate by the determined weighted value of the second use rate;
adding the first product, the second product, the third product, the fourth product, and the determined ambient temperature value; and
using the sum obtained by the adding as the temperature value of the server with the largest temperature value at the current time after the first virtual machine is migrated out from the server with the largest temperature value at the current time.

5. The method according to claim 3, wherein determining the weighted value of the first air outlet temperature, the weighted value of the first air inlet temperature, the weighted value of the first use rate, the weighted value of the second use rate, and the ambient temperature value comprises:
acquiring second air outlet temperature obtained by collecting, at each sampling time point in a period of time previous to the current time, the temperature at the air outlet of the server with the largest temperature value at the current time;
acquiring third air outlet temperature obtained by collecting, at a specified time point corresponding to each sampling time point, the temperature at the air outlet of the server with the largest temperature value at the current time;
acquiring second air inlet temperature obtained by collecting, at the specified time point corresponding to each sampling time point, the temperature at the air inlet of the server with the largest temperature value at the current time;
acquiring a third use rate of the specified hardware device of the server with the largest temperature value at the current time, wherein the third use rate is specific to each virtual machine in the server with the largest temperature value at the current time, and the third use rate is collected at the specified time point corresponding to each sampling time point;
acquiring a fourth use rate of the specified hardware device of the server with the largest temperature value at the current time, wherein the fourth use rate is collected in second specified duration corresponding to each sampling time point;
using the acquired second air outlet temperature as a dependent variable;
separately using the acquired third air outlet temperature, second air inlet temperature, third use rate, and fourth use rate as an independent variable; and
determining, using the weighted summing manner, the weighted value of the first air outlet temperature, the weighted value of the first air inlet temperature, the weighted value of the first use rate, the weighted value of the second use rate, and the ambient temperature value,
wherein the specified time point corresponding to any sampling time point is previous to the any sampling time point, and
wherein a duration between the specified time point corresponding to the any sampling time point and the any sampling time point is equal to duration between the current time and a set prediction time point, and
wherein the second specified duration corresponding to the any sampling time point is a period of time that is previous to the specified time point corresponding to the any sampling time point and any duration away from the corresponding specified time point.

6. The method according to claim 1, wherein selecting the destination server from other servers that are part of the data center except the server with the largest temperature value at the current time comprises:
selecting, from the other servers that are part of the data center except the server with the largest temperature value at the current time and by means of screening, a server that does not comprise a virtual machine mutually exclusive with the determined to-be-migrated virtual machine, and/or selecting, from the other servers that are part of the data center except the server with the largest temperature value at the current time and by means of screening, a server that has an idle resource and meets a resource requirement of the determined to-be-migrated virtual machine;
predicting a temperature value of each selected server available after the determined to-be-migrated virtual machine is migrated to each selected server; and
using a server that is in the selected server and whose corresponding predicted temperature value is less than the largest temperature value as the selected destination server.

7. The method according to claim 6, wherein using the server that is in the selected server and whose corresponding predicted temperature value is less than the largest temperature value as the selected destination server comprises using any server that is in the selected server and whose temperature value is less than the largest temperature value as the selected destination server.

8. The method according to claim 6, wherein predicting the temperature value of each selected server available after the determined to-be-migrated virtual machine is migrated to each selected server, and using a server that is in the selected server and whose corresponding predicted temperature value is less than the largest temperature value as the selected destination server comprises performing the following steps, which are performed on a first server, on each server in the selected servers, wherein the first server is any server in the selected servers:
predicting temperature values of the first server and the server with the largest temperature value at the current time after the determined to-be-migrated virtual machine is migrated to the first server;
calculating a difference between a largest temperature value and a smallest temperature value in the following temperature values: the predicted temperature value of the first server, the predicted temperature value of the server with the largest temperature value at the current time after the determined to-be-migrated virtual machine is migrated to the first server, and the measured temperature values obtained by separately measuring other servers in the data center except the first server and the server with the largest temperature value at the current time; and
determining a server corresponding to a smallest difference, from a calculated difference corresponding to each server in the selected servers, as the selected destination server.

9. The method according to claim 8, wherein predicting the temperature value of the first server available after the determined to-be-migrated virtual machine is migrated to the first server comprises:
acquiring fourth air outlet temperature obtained by collecting temperature at an air outlet of the first server at the previous sampling time point adjacent to the current time;
acquiring third air inlet temperature obtained by collecting temperature at an air inlet of the first server at the previous sampling time point adjacent to the current time;
acquiring a first use rate of the specified hardware device of the server with the largest temperature value at the current time, wherein the first use rate is specific to the determined to-be-migrated virtual machine, and the first use rate is collected at the previous sampling time point adjacent to the current time;
acquiring first total storage space of the server with the largest temperature value at the current time, and acquiring second total storage space of the first server;
acquiring a fifth use rate of a specified hardware device of the first server, wherein the fifth use rate is collected at each sampling time point that is previous to the current time and in the first specified duration;
obtaining a fifth product by multiplying the acquired fourth air outlet temperature by the determined weighted value of the first air outlet temperature;
obtaining a sixth product by multiplying the acquired third air inlet temperature by the determined weighted value of the first air inlet temperature;
obtaining a seventh product by multiplying a product of the acquired first use rate and the determined weighted value of the first use rate by a ratio of the acquired second total storage space to the first total storage space;
obtaining an eighth product by multiplying the acquired fifth use rate by the determined weighted value of the second use rate; and
adding the fifth product, the sixth product, the seventh product, the eighth product, and the determined ambient temperature value, and using the sum obtained by the adding as the predicted temperature value of the first server available after the determined to-be-migrated virtual machine is migrated to the first server.

10. The method according to claim 8, wherein predicting the temperature value of the server with the largest temperature value at the current time after the determined to-be-migrated virtual machine is migrated to the first server comprises:
acquiring the first air outlet temperature obtained by collecting, at the previous sampling time point adjacent to the current time, the temperature at the air outlet of the server with the largest temperature value at the current time;
acquiring the first air inlet temperature obtained by collecting, at the previous sampling time point adjacent to the current time, the temperature at the air inlet of the server with the largest temperature value at the current time;
acquiring the first use rate of the specified hardware device of the server with the largest temperature value at the current time, wherein the first use rate is specific to the determined to-be-migrated virtual machine, and the first use rate is collected at the previous sampling time point adjacent to the current time;
acquiring the second use rate of the specified hardware device of the server with the largest temperature value at the current time, wherein the second use rate is collected at each sampling time point that is previous to the current time and in the first specified duration;
obtaining the first product by multiplying the acquired first air outlet temperature by the weighted value of the first air outlet temperature;
obtaining the second product by multiplying the acquired first air inlet temperature by the weighted value of the first air inlet temperature;
obtaining the third product by multiplying the acquired first use rate by the weighted value of the first use rate;
obtaining the fourth product by multiplying the acquired second use rate by the weighted value of the second use rate;
adding the first product, the second product, the third product, the fourth product, and the ambient temperature value; and
using the sum obtained by the adding as the predicted temperature value of the server with the largest temperature value at the current time after the determined to-be-migrated virtual machine is migrated from the server with the largest temperature value at the current time to the first server.

11. An apparatus for migrating a virtual machine, comprising:
an acquiring unit configured to acquire a temperature value of each server in a data center at a current time;
a calculating unit configured to:
determine a largest temperature value and a smallest temperature value from the acquired temperature values of the servers in the data center; and
calculate a difference between the largest temperature value and the smallest temperature value;
a determining unit configured to determine a to-be-migrated virtual machine from a server with the largest temperature value at the current time when it is determined that the difference reaches a preset threshold, wherein the preset threshold is greater than or equal to 0;
a selecting unit configured to select a destination server from other servers that are part of the data center except the server with the largest temperature value at the current time, wherein the selected destination server meets the following condition: after the determined to-be-migrated virtual machine is migrated to the destination server, a temperature value of the destination server is less than the largest temperature value; and
a migrating unit configured to migrate the determined to-be-migrated virtual machine to the destination server.

12. The apparatus according to claim 11, wherein when determining the to-be-migrated virtual machine from the server with the largest temperature value at the current time, the determining unit is configured to:
calculate a value of temperature effect exerted on the server with the largest temperature value at the current time by each virtual machine in the server with the largest temperature value at the current time, wherein the value of temperature effect exerted on the server with the largest temperature value at the current time by each virtual machine is a temperature value variation of the server with the largest temperature value at the current time when each virtual machine runs in the server with the largest temperature value at the current time;
determine a largest value of temperature effect from the calculated values of temperature effect exerted on the server with the largest temperature value at the current time separately by all virtual machines; and
use a virtual machine with the determined largest value of temperature effect as the determined to-be-migrated virtual machine.

13. The apparatus according to claim 12, wherein when calculating the value of temperature effect exerted on the server with the largest temperature value at the current time by each virtual machine in the server with the largest temperature value at the current time, the determining unit is configured to:
acquire first air outlet temperature obtained by collecting, at a previous sampling time point adjacent to the current time, temperature at an air outlet of the server with the largest temperature value at the current time, and first air inlet temperature obtained by collecting, at the previous sampling time point adjacent to the current time, temperature at an air inlet of the server with the largest temperature value;
acquire a first use rate of a specified hardware device of the server with the largest temperature value at the current time, wherein the first use rate is specific to each virtual machine in the server with the largest temperature value at the current time, the first use rate is collected at the previous sampling time point adjacent to the current time, and the specified hardware device has an attribute that heat is generated and the generated heat changes with load of the specified hardware device;
acquire a second use rate of the specified hardware device of the server with the largest temperature value at the current time, wherein the second use rate is collected at each sampling time point in first specified duration previous to the current time;
based on the first air outlet temperature, the first air inlet temperature, the first use rate, and the second use rate that are acquired, and a weighted value of the first air outlet temperature, a weighted value of the first air inlet temperature, a weighted value of the first use rate, a weighted value of the second use rate, and an ambient temperature value that are determined, predict, using a weighted summing manner, a temperature value of the server with the largest temperature value at the current time available after each virtual machine in the server with the largest temperature value at the current time is migrated out from the server with the largest temperature value at the current time; and
perform the following step, which is performed on a first virtual machine, on each virtual machine in the server with the largest temperature value at the current time, wherein the first virtual machine is any virtual machine in all virtual machines in the server with the largest temperature value at the current time: using an absolute value of a temperature difference between a predicted temperature value and the acquired first air outlet temperature as a value of temperature effect exerted on the server with the largest temperature value at the current time by the first virtual machine, wherein the predicted temperature value is a temperature value of the server with the largest temperature value at the current time after the first virtual machine is migrated out from the server with the largest temperature value at the current time.

14. The apparatus according to claim 13, wherein when predicting, using the weighted summing manner, the temperature value of the server with the largest temperature value at the current time available after each virtual machine in the server with the largest temperature value at the current time is migrated out from the server with the largest temperature value at the current time, the determining unit is configured to perform the following steps, which are performed on the first virtual machine, on each virtual machine in the server with the largest temperature value at the current time:
obtaining a first product by multiplying the acquired first air outlet temperature by the determined weighted value of the first air outlet temperature;
obtaining a second product by multiplying the acquired first air inlet temperature by the determined weighted value of the first air inlet temperature;
obtaining a third product by multiplying the acquired first use rate by the determined weighted value of the first use rate;
obtaining a fourth product by multiplying the acquired second use rate by the determined weighted value of the second use rate;
adding the first product, the second product, the third product, the fourth product, and the determined ambient temperature value; and
using the sum obtained by the adding as the temperature value of the server with the largest temperature value at the current time after the first virtual machine is migrated out from the server with the largest temperature value at the current time.

15. The apparatus according to claim 13, wherein when determining the weighted value of the first air outlet temperature, the weighted value of the first air inlet temperature, the weighted value of the first use rate, the weighted value of the second use rate, and the ambient temperature value, the determining unit is configured to:
acquire second air outlet temperature obtained by collecting, at each sampling time point in a period of time previous to the current time, the temperature at the air outlet of the server with the largest temperature value at the current time;
acquire third air outlet temperature obtained by collecting, at a specified time point corresponding to each sampling time point, the temperature at the air outlet of the server with the largest temperature value at the current time;
acquire second air inlet temperature obtained by collecting, at the specified time point corresponding to each sampling time point, the temperature at the air inlet of the server with the largest temperature value at the current time;
acquire a third use rate of the specified hardware device of the server with the largest temperature value at the current time, wherein the third use rate is specific to each virtual machine in the server with the largest temperature value at the current time, and the third use rate is collected at the specified time point corresponding to each sampling time point;
acquire a fourth use rate of the specified hardware device of the server with the largest temperature value at the current time, wherein the fourth use rate is collected in second specified duration corresponding to each sampling time point;
use the acquired second air outlet temperature as a dependent variable;
separately use the acquired third air outlet temperature, the second air inlet temperature, the third use rate, and the fourth use rate as an independent variable; and
determine, using the weighted summing manner, the weighted value of the first air outlet temperature, the weighted value of the first air inlet temperature, the weighted value of the first use rate, the weighted value of the second use rate, and the ambient temperature value,
wherein the specified time point corresponding to any sampling time point is previous to the any sampling time point,
wherein the duration between the specified time point corresponding to the any sampling time point and the any sampling time point is equal to duration between the current time and a set prediction time point; and
wherein the second specified duration corresponding to the any sampling time point is a period of time that is previous to the specified time point corresponding to the any sampling time point and any duration away from the corresponding specified time point.

16. The apparatus according to claim 11, wherein when selecting the destination server from the other servers that are part of the data center except the server with the largest temperature value at the current time, the selecting unit is configured to:
select, from the other servers that are part of the data center except the server with the largest temperature value at the current time and by means of screening, a server that does not comprise a virtual machine mutually exclusive with the determined to-be-migrated virtual machine, and/or select, from the other servers that are part of the data center except the server with the largest temperature value at the current time and by means of screening, a server that has an idle resource and meets a resource requirement of the determined to-be-migrated virtual machine;
predict a temperature value of each selected server available after the determined to-be-migrated virtual machine is migrated to each selected server; and
use a server that is in the selected server and whose corresponding predicted temperature value is less than the largest temperature value as the selected destination server.

17. The apparatus according to claim 16, wherein when using the server that is in the selected server and whose corresponding predicted temperature value is less than the largest temperature value as the selected destination server, the selecting unit is configured to use any server that is in the selected server and whose temperature value is less than the largest temperature value as the selected destination server.

18. The apparatus according to claim 16, wherein when using the server that is in the selected server and whose corresponding predicted temperature value is less than the largest temperature value as the selected destination server, the selecting unit is configured to:
perform the following steps, which are performed on a first server, on each server in the selected servers, wherein the first server is any server in the selected servers:
predict temperature values of the first server and the server with the largest temperature value at the current time after the determined to-be-migrated virtual machine is migrated to the first server;
calculate a difference between a largest temperature value and a smallest temperature value in the following temperature values: the predicted temperature value of the first server, the predicted temperature value of the server with the largest temperature value at the current time after the determined to-be-migrated virtual machine is migrated to the first server, and the measured temperature values obtained by separately measuring other servers in the data center except the first server and the server with the largest temperature value at the current time; and
determine a server corresponding to a smallest difference, from a calculated difference corresponding to each server in the selected servers, as the selected destination server.

19. The apparatus according to claim 18, wherein when predicting the temperature value of the first server available after the to-be-migrated virtual machine is migrated to the first server, the selecting unit is configured to:
acquire fourth air outlet temperature obtained by collecting temperature at an air outlet of the first server at the previous sampling time point adjacent to the current time;
acquire third air inlet temperature obtained by collecting temperature at an air inlet of the first server at the previous sampling time point adjacent to the current time;
acquire a first use rate of the specified hardware device of the server with the largest temperature value at the current time, wherein the first use rate is specific to the determined to-be-migrated virtual machine, and wherein the first use rate is collected at the previous sampling time point adjacent to the current time;
acquire first total storage space of the server with the largest temperature value at the current time; and
acquire second total storage space of the first server;
acquire a fifth use rate of a specified hardware device of the first server, wherein the fifth use rate is collected at each sampling time point that is previous to the current time and in the first specified duration;
obtain a fifth product by multiplying the acquired fourth air outlet temperature by the determined weighted value of the first air outlet temperature;
obtain a sixth product by multiplying the acquired third air inlet temperature by the determined weighted value of the first air inlet temperature;
obtain a seventh product by multiplying a product of the acquired first use rate and the determined weighted value of the first use rate by a ratio of the acquired second total storage space to the first total storage space;
obtain an eighth product by multiplying the acquired fifth use rate by the determined weighted value of the second use rate;
add the fifth product, the sixth product, the seventh product, the eighth product, and the determined ambient temperature value; and
use the sum obtained by the adding as the predicted temperature value of the first server available after the determined to-be-migrated virtual machine is migrated to the first server.

20. The apparatus according to claim 18, wherein when predicting the temperature value of the server with the largest temperature value at the current time after the determined to-be-migrated virtual machine is migrated to the first server, the selecting unit is configured to:
acquire the first air outlet temperature obtained by collecting, at the previous sampling time point adjacent to the current time, the temperature at the air outlet of the server with the largest temperature value at the current time;
acquire the first air inlet temperature obtained by collecting, at the previous sampling time point adjacent to the current time, the temperature at the air inlet of the server with the largest temperature value at the current time;
acquire the first use rate of the specified hardware device of the server with the largest temperature value at the current time, wherein the first use rate is specific to the determined to-be-migrated virtual machine, and wherein the first use rate is collected at the previous sampling time point adjacent to the current time;
acquire the second use rate of the specified hardware device of the server with the largest temperature value at the current time, wherein the second use rate is collected at each sampling time point that is previous to the current time and in the first specified duration;
obtain the first product by multiplying the acquired first air outlet temperature by the weighted value of the first air outlet temperature;
obtain the second product by multiplying the acquired first air inlet temperature by the weighted value of the first air inlet temperature;
obtain the third product by multiplying the acquired first use rate by the weighted value of the first use rate;
obtain the fourth product by multiplying the acquired second use rate by the determined weighted value of the second use rate;
add the first product, the second product, the third product, the fourth product, and the ambient temperature value; and
use the sum obtained by the adding as the predicted temperature value of the server with the largest temperature value at the current time after the determined to-be-migrated virtual machine is migrated from the server with the largest temperature value at the current time to the first server.

21. A system for migrating a virtual machine, comprising:
a data center, wherein the data center comprises at least one server, and wherein each server in the at least one server comprises at least one virtual machine; and
an apparatus for migrating the virtual machine, comprising:
an acquiring unit configured to acquire a temperature value of each server in the data center at a current time;
a calculating unit configured to:
determine a largest temperature value and a smallest temperature value from the acquired temperature values of the servers in the data center; and
calculate a difference between the largest temperature value and the smallest temperature value;
a determining unit configured to determine a to-be-migrated virtual machine from a server with the largest temperature value at the current time when it is determined that the difference reaches a preset threshold, wherein the preset threshold is greater than or equal to 0;
a selecting unit configured to select a destination server from other servers that are part of the data center except the server with the largest temperature value at the current time, wherein the selected destination server meets the following condition: after the determined to-be-migrated virtual machine is migrated to the destination server, a temperature value of the destination server is less than the largest temperature value; and
a migrating unit configured to migrate the determined to-be-migrated virtual machine to the destination server.
